(19) United States
(12) Patent Application Publication
(10) Pub. No.: US 2008/0223918 A1
(43) Pub. Date: Sep. 18, 2008

(54) PAYMENT TOKENS

(75) Inventors: Charles J. Williams, Redmond, WA (US); Sergey I. Bykov, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/686,630

(22) Filed: Mar. 15, 2007

(51) Int. Cl. G07F 19/00; G06Q 90/00

(52) U.S. Cl. 235/379; 705/67

(57) ABSTRACT

Systems and methods of payment processing via employing a payment token(s) that is supplied to smart portable devices, which are carried by customers. Such a token can be in form of a unique identifier(s) (which is generated by an issuing bank and received by the smart portable devices), and is associated with a payment amount for a merchant. Moreover, the point of sale (POS) terminal can accept the token offline, and hence a requirement for availability of communication between the POS and a payment processor/issuing bank can be mitigated.

### BACKGROUND

Retail establishments strive to become more efficient by applying different and innovative operating methods that help increase their business's financial condition. One of the constantly pursued goals is the secure processing of electronic consumer payments such as credit cards, debit card, gift cards, and the like.

For example, low security of credit cards presents countless opportunities for fraud. This opportunity has created a huge black market in stolen credit card numbers, which are generally used quickly before the cards are reported stolen. Such fraudulent transaction are typically performed via stolen credit card information, which can be obtained in many ways, the simplest being copying information from retailers, either online or offline. Moreover, there exist many cases of crackers obtaining huge quantities of credit card information from company databases. It is not unusual for employees of companies that deal with millions of customers to sell credit card information to criminals. Fraudulent transactions associated with card processing can significantly reduce revenues of retailers (e.g., not only because retailers increasingly are required to pay for fraudulent transactions, but also because fraud is one component of the increasing interchange fees.)

Despite efforts to improve security for remote purchases using credit cards, systems with security holes are usually the result of poor implementations of card acquisition by merchants. Typically, a two-step process is often required, wherein initially the merchant is to contact the payment processor and subsequently such payment processor has to contact the issuing bank and verify validity of the supplied information. For example, a website that employs Secure Sockets Layer (SSL) to encrypt card numbers from a client may simply email the number from the webserver to someone who manually processes the card details at a card terminal. Naturally, anywhere card details become human-readable before being processed at the acquiring bank is a security risk. In general, such payment processing is the process of settling charges with issuing/acquiring banks.

In addition, there are many situations where complexities and inefficiencies are created by employment of such billing mechanisms. For example, many customers have multiple or sometimes interconnected relationships between service providers and other parties. This often requires maintenance of multiple accounts in order to service a single customer. In addition, fees associated with card processing transactions are increasingly consuming merchants' profits. For example, in the grocery business where the margins are around 3%, retailers are paying up to 2% towards processing of the credit/debit card transactions. Such has caused many merchants (especially ones involved in low margins and low price businesses) to look for alternatives to credit cards.

Moreover, conventional payment processing processes typically involve maintaining on line availability between the merchant and the bank at all times. This can unnecessarily strain a system at inopportune times—e.g., where the system is encountering high system loads.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

The subject innovation provides for systems and method of payment processing, via employing a payment token(s) that is supplied to smart portable devices (e.g., mobile computer, cell phone, and the like) that are carried by consumers. Such token can be in form of a unique identifier(s) (which is generated by an issuing bank and received by the smart portable devices) and is associated with a payment amount for a merchant (e.g., a predetermined store). Moreover, the point of sale (POS) terminal can accept the token offline, and hence a requirement for availability of communication between the POS and a payment processor/issuing bank can be mitigated. The token can also be forwarded to consumers upfront, and hence a requirement for connecting to the issuer from a merchant's location can be mitigated, for example.

In a related aspect, instead of passing payment instrument data such as magnetic tracks of a credit card or check credentials, the smart portable device can communicate directly with the issuing bank of the payment instrument, and receive an electronic payment token for the particular merchant, amount and a reasonable expiration date. Such payment token can be digitally signed by the issuing bank or by a trusted authority, so that the POS terminal can verify integrity of the token either by sending it to its payment processor or locally on the terminal. Put differently, the token will play the same role of the “promise to pay” approval code that a conventional POS terminal receives from its payment processor in response to a submitted transaction. Also, the tokens can be linked to a predetermined consumer's account with the issuing bank, such as credit, debit, gift, benefits, money market, and the like (e.g., without a change on the POS side.) A plurality of biometric indicia can further be employed when initiating operation of the smart portable device with the issuing bank.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 illustrates an exemplary block diagram of a business commerce network that employs payment tokens in accordance with an aspect of the subject innovation.

FIG. 2 illustrates a particular block diagram for a general retail environment that employs payment tokens according to a particular aspect of the subject innovation.

FIG. 3 illustrates a methodology of obtaining payment tokens in accordance with an aspect of the subject innovation.

FIG. 4 illustrates a related methodology of processing payment tokens in accordance with an aspect of the subject innovation.

FIG. 5 illustrates a particular payment token processing entity in accordance with an aspect of the subject innovation.

FIG. 6 illustrates a token processing workflow in accordance with an aspect of the subject invention.

FIG. 7 illustrates a token processing entity that further incorporates an error detection/correction component as part of a token processing system according to an aspect of the subject innovation.

FIG. 8 illustrates a block diagram of a shopping network system that employs an online storage component and combines coupon processing with token processing.

FIG. 9 illustrates a schematic block diagram of a suitable operating environment for implementing aspects of the subject innovation.

FIG. 10 illustrates a further schematic block diagram of a sample-computing environment for the subject innovation.

### DETAILED DESCRIPTION

The various aspects of the subject innovation are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

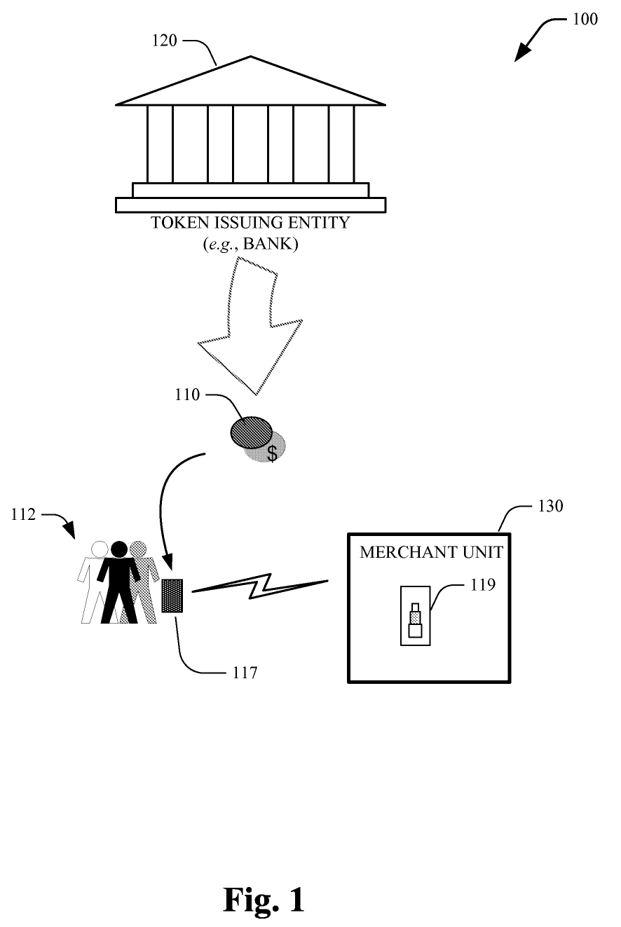

FIG. 1 illustrates a block diagram of a shopping network system 100 that employs a payment token(s) in accordance with an aspect of the subject innovation. The payment token 110 can include substantially any type of electronic code, data packet or signature including secure electronic data provided by encryption techniques. Moreover, the payment token can be in form of an electronic document issued to consumer by a financial institution with which the consumer has an account (credit, checking, and the like.) Such document can be signed with a digital signature of the issuer so that integrity of the token can be validated. In addition, the document can include information about the issuer, the merchant to which it is issued, the amount of the transaction, the identity of the accountholder (e.g., name), and the like.

For example, the payment token 110 can implement unique single instance of a string that carry monetary value and allows a user(s) 112 to be eligible to purchase an offer. Each payment token can be validated and/or accepted before use either on-line or off-line as described in detail infra. In general, the payment token 110 can be employed for a single time and for a merchant who supplies the payment request to the smart portable devices 117 that are carried by customers 112. The smart portable devices 117 are intelligent devices with computing and processing capabilities, such as portable computers, personal digital assistants, mobile phones, digital music players and the like, which can further supply identifications and communicate with the token issuing entity (e.g., issuing bank) 120. The smart portable device 117 can connect to the merchant unit 130 (which includes POS terminal 119) over a cell network, public wireless network, merchant's wired or wireless network or over a Bluetooth or NFC connection and the like, for example.

The POS terminal 119 can supply a payment request to the smart portable devices 117, when a purchase transaction is initiated thereby. Upon receipt of such payment request, the smart mobile devices 117 can communicate with the issuing bank via a secure link, e.g., HTTPS. Such communication can require verification for a pin number, biometrics indicia and the like. The token issuing entity 120 can generate, and subsequently return the payment token 110 that can include identification for the merchant unit 130, value and amount associated with the token 110, identification of the token issuing entity 120 and the like. Upon receipt of the payment token, the smart portable device 117 passes the token 110 to the point of sale 119. The POS terminal 119 can verify integrity of the token 110 either by sending it to its payment processor or locally on the terminal. Put differently, the token 110 will play the same role of the “promise to pay” approval code that conventional POS terminals receive from their payment processor in response to a submitted transaction, for example.

The payment token 110 can subsequently be deposited by the merchant to a merchant bank (not shown), either online or offline, for example. It is to be appreciated that other third party processors and/or payment gateways can exist between the merchant unit 130 and merchant bank, to verify the payment token 110 and a deposit thereof on merchant's behalf. The merchant unit 130 can further include: a central host computer operatively connected to a plurality of in-store customer sale terminals that can represent point of sale (POS) 119; a wireless local area network that includes a plurality of access points; and a wired backbone for communicating data between the central host and the customer sale terminals (not shown).

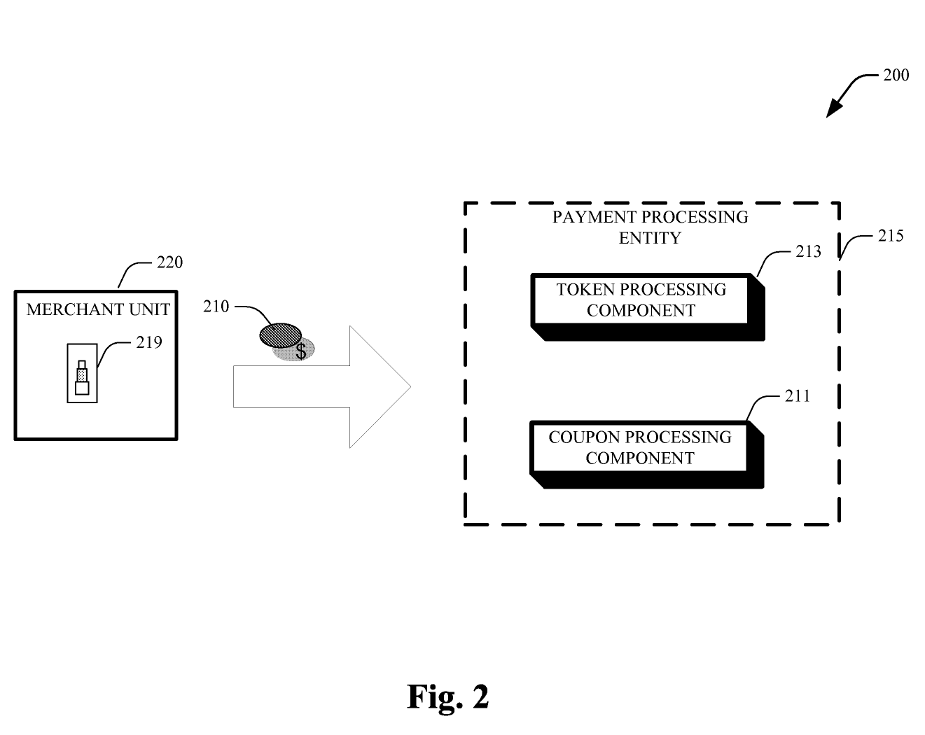

FIG. 2 illustrates a block diagram of processing system 200 that can process payment tokens 210 in accordance to a further aspect of the subject innovation. Upon receipt of the payment token 210 from the smart mobile device (not shown), the POS terminal 219 sends the payment token to its payment processing entity 215 for validation. The token processing component 213 can validate the digital signature and certificate of the issuing bank, which is associated with the token 210.

For example, the token processing component 213 typically need not connect to the issuing bank or card association, and validation can be performed by the processing entity 215 itself. It is to be appreciated that the POS terminal 219 can also perform validation of the token by itself without the need to connect to external entities. The token processing component 213 can confirm validity of the token 210 by responding with a confirmation message. Moreover, the token processing component 211 can also deposit the token 210 for settlement, wherein at an end of such settlement period, the merchants' bank can submit the payment token to the issuing bank and requests funds transfer, for example.

In a related aspect, the payment processing entity 215 can combine processing of payment tokens with processing of coupon data, wherein such payment processing entity 215 can further function as the coupon clearinghouse between coupon issuers and merchants. Such a network can be implemented in connection with a commercial transaction (e.g., for a retail, electronic web purchases, grocery stores, and the like), and can include proprietary network transaction data flows on payment gateways, which take payment requests from merchant and route such request to proper processing entities.

Furthermore, the merchant unit 220 can accept coupon data via the smart portable devices such as intelligent devices like mobile computer, personal digital assistant, cell phone and the like), which are carried by the customer, as described supra, for example. Such intelligent devices can supply identifying information, coupon data and payment information to the merchant 220, via an exchange of information therewith. The coupon data can be processed by the coupon processing component 211, wherein coupon data can be cleared the respective manufacturer for reimbursement of the merchant (e.g., retailer.) Hence, an operation of the processing component 215 can integrate both operations relating to token processing and coupon clearance.

For example, the merchant unit 220 can receive coupon data and token information and send such information as a single request to payment processing entity 215. It is to be appreciated that the merchant unit 220 can receive coupon data for paper coupons via an input component such as a scan read. The network can also include a plurality of manufacturer's servers, each corresponding to the manufacturer of a product available at the merchant's store. Each manufacturer's server can be communicatively coupled to the merchant's host via the internet, for example.

As such, the subject innovation can leverage the existing security protocols and payment processing infrastructure, to facilitate processing of tokens and/or coupons. Moreover, existing trust relations that have been established can be employed (e.g., established relationships between banks, merchants, and payment processing entities.)

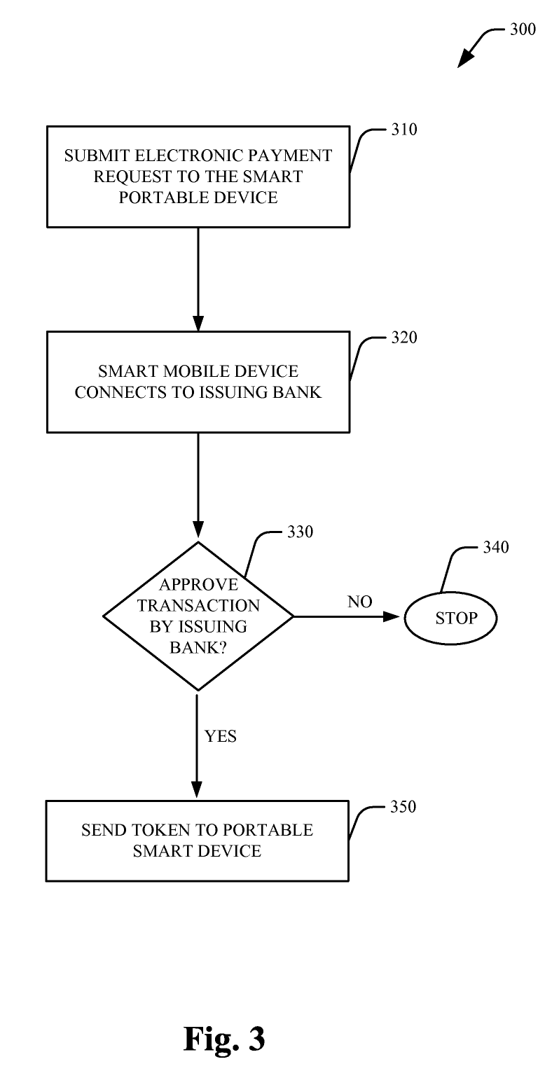

FIG. 3 illustrates a related methodology 300 of employing in accordance with an aspect of the subject innovation. While the exemplary method is illustrated and described herein as a series of blocks representative of various events and/or acts, the subject innovation is not limited by the illustrated ordering of such blocks. For instance, some acts or events may occur in different orders and/or concurrently with other acts or events, apart from the ordering illustrated herein, in accordance with the innovation. In addition, not all illustrated blocks, events or acts, may be required to implement a methodology in accordance with the subject innovation. Moreover, it will be appreciated that the exemplary method and other methods according to the innovation may be implemented in association with the method illustrated and described herein, as well as in association with other systems and apparatus not illustrated or described. At 310, an electronic payment request that contains a merchant's identification (e.g., certificate) and payment amount required for the transaction is submitted to the smart portable device. Such payment request can include additional information such as basket data, for example. Next and at 320 the smart portable device connects to the issuing bank and submits the request along with consumer's ID. Other information, such as consumer's choice of the account that is to be used for the transaction can also be supplied (e.g., a specific bank account, choice of acquiring bank and the like). Additionally, the act 320 can require authentication of the consumer such as PIN, biometrics, and other sensitive information, for example. Next and at 330 a determination is made by the issuing banks as to whether such transaction is approved. If not, the methodology 300 halts at 340, and an error notification is sent to the smart portable device. Otherwise, the methodology proceeds to act 350 wherein a token is sent from the issuing bank to the smart mobile device.

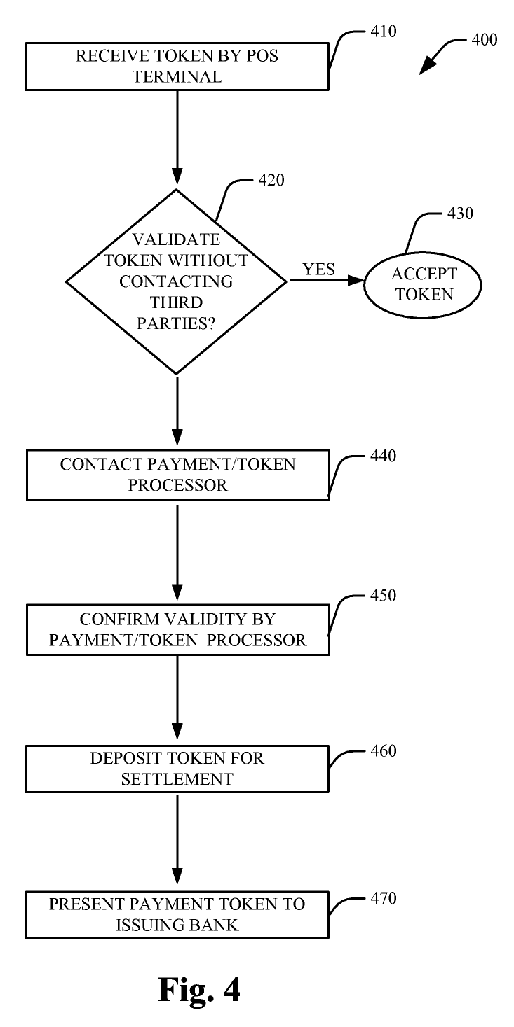

FIG. 4 illustrates a related methodology 400 in accordance with an aspect of the subject innovation. Initially and at 410, a token is received by the POS terminal (e.g., sent thereto via a smart mobile device that can be carried by the customer during purchasing events.) The token can include the merchant's ID, the amount, the ID/certificate of the issuing bank and, optionally, a reference to consumer's identity such as name but no information about the payment account being used for the transaction.

In a related aspect, such token cannot be redeemed by any other merchant, and its value (e.g., payment amount) cannot be altered since the token is digitally signed by the issuing bank's private key. Subsequently, and at 420 a decision is performed by the POS terminal as to validate the token itself without contacting third party entities (e.g., the issuing bank). The validation act can depend upon various decision-making factors such as amount of token, reputation of the issuing bank, purchase history of the customer, and the like. If POS can validate token based on such decision-making factors, then token is accepted at 430. Otherwise, the methodology proceeds to contacting a payment processor at 440. The payment processor can confirm validity of the token by responding with a confirmation message at 450, and can also deposit the token for settlement at 460. Subsequently, and at 470 merchant's bank presents the payment token to the issuing bank and requests funds transfer. It is to be appreciated that further validations such as: validation of the issuer of the token; validation regarding whether monetary value of the token matches the requested amount; validation that the token is issued for the particular merchant who possesses the token ; validation of the account holder such as name, photo, and the like can also be performed, and are well within the realm of the subject innovation.

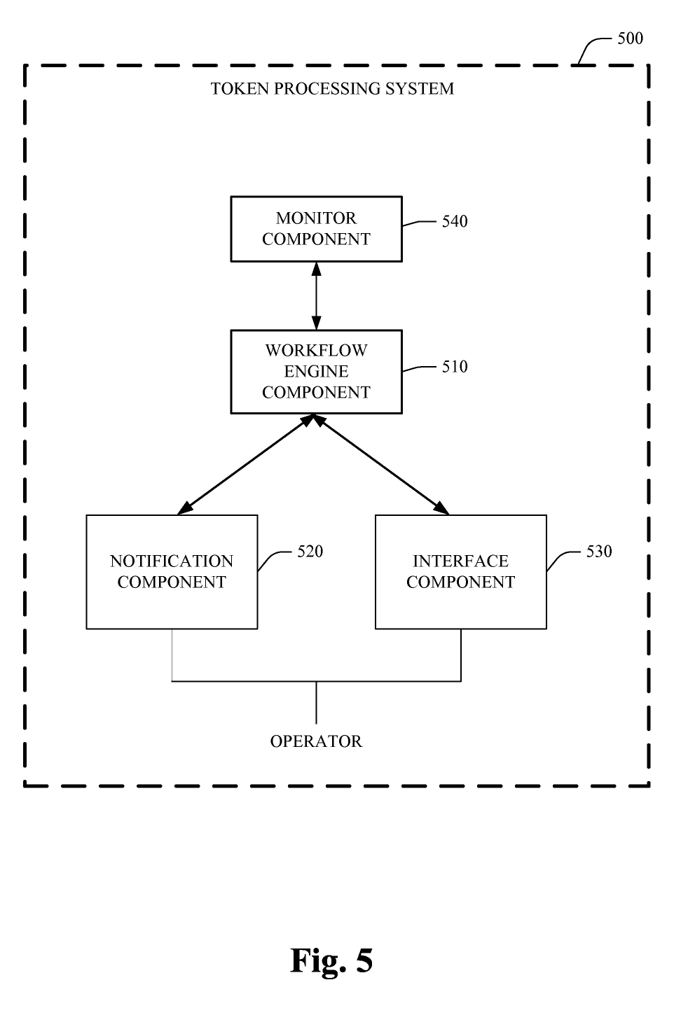

FIG. 5 illustrates a particular token processing entity 500 in accordance with an aspect of the subject innovation. The payment token transaction received by the token processing entity 500 can be validated and/or accepted before use either on-line or off-line. In addition, the received payment token can be employed for a single time and for a merchant that is associated with the token processing entity 500. The token can further include information such as: identification for the merchant, value and amount associated with the token, identification of the issuing bank and the like.

The token processing system 500 can implement: a workflow engine component 510; a notification component 520; an interface component 530, and a monitor component 540. The workflow engine component 510 executes and manages workflow process instances. A workflow is a sequence or series of tasks used to manage and monitor processes the token processing and/or settlement. For example, a workflow instance can be instantiated for settlement of the payment tokens with third parties (e.g., acquiring banks, issuing banks and the like). The workflow engine component 510 can execute a series of tasks provided to it via a workflow instance associated with electronic coupon processing and payment processing. Tasks associated with the workflow can include creating a file, sending a file, retrieving a file, validating a file, reconciling a file, providing notification to a user or operator, retrieving information from a user or operator, and the like. The workflow engine component 510 can further employ a queue (not shown) to execute tasks with higher priority before tasks with lower priority, wherein tasks related to processing a token can be performed separate, or in conjunction with tasks for processing other forms of payments.

Furthermore, when a workflow act or task requires operator input, workflow engine component 510 interacts with the notification component 520 to notify an operator that a related input is required. Such notification can employ a context analyzer (not shown) and statistical models to infer a best communication medium upon which to provide a notification (e.g., pop-up window, email, mobile phone, office phone, personal digital assistant (PDA), pager . . . ) to customers and/or operator of the POS terminal. Upon notification, an operator can communicate with the workflow execution engine via the user interface component 530. For example, the interface component 530 can be a graphical user interface (GUI) that facilitates interaction and transfer of information.

Token processing system 500 can also includes a monitor component 540, which monitors system resources to determine whether to increase the rate of executing tasks (e.g., from a queue), decrease the rate of tasks executing, or hold the rate of task execution at the same rate. This information can then be provided to the workflow engine component 510 to effect the execution of token processing tasks.

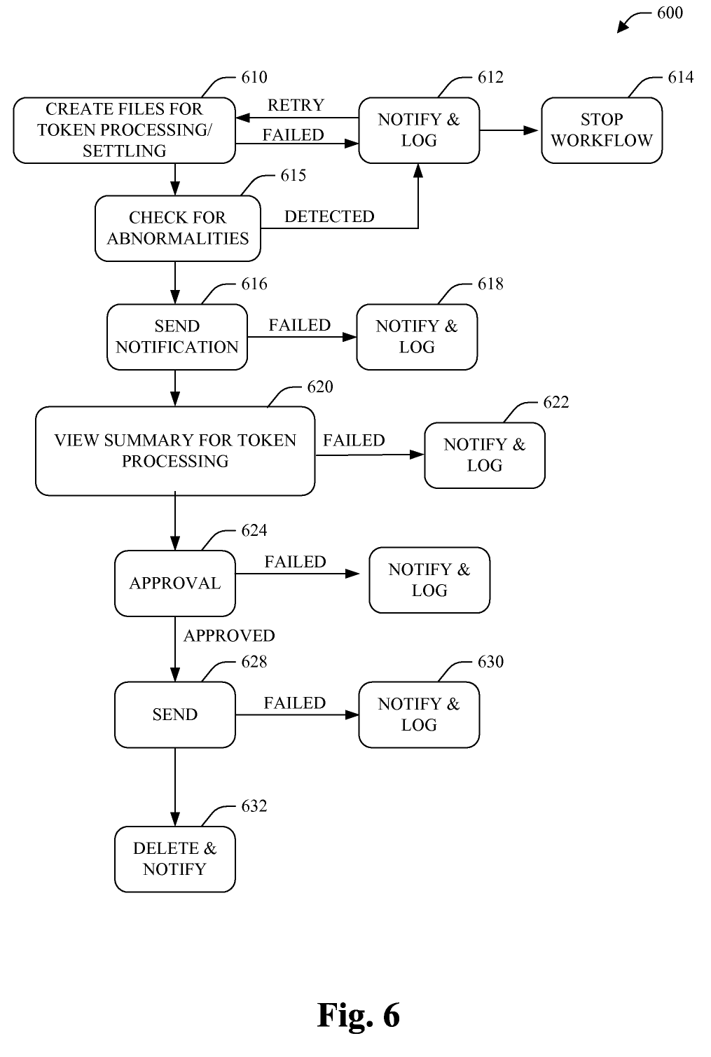

FIG. 6 illustrates a token processing workflow 600 in accordance with an aspect of the subject invention. The workflow 600 provides for activities such as: creating a file(s) containing purchasing information for the payment token (e.g., for settling and processing such token); obtaining approval by a human operator (e.g. at the POS), and subsequently sending out data to the token issuing bank and/or payment provider. At 610, a file is created in response to a user request for purchasing an item via a payment token associated with such purchase transaction. The payment token can be supplied to the merchant at the POS via a smart portable device that receives the payment taken from an issuing bank, as described in detail supra.

At 610, a file can be created when a user indicates a desire to purchase a product over the Internet, for example. Alternatively, a user can set up a schedule to periodically supply tokens, e.g., for a monthly service (e.g., subscription). If the file creation fails at 610, then such failure is logged (e.g., in a database) and a user or operator is notified of the failure at 612. Moreover, the workflow 600 can retry to create the files at 610 based on predetermined criteria, such as retrying a plurality of times and/or after a certain period. If after performance of such predetermined criteria the file(s) related to the token processing are not created, then the workflow stops at 614 and the POS operator and the consumer are notified.

If the file(s) are successfully created, a process is initiated to determine if there are any abnormalities in the created file(s) at 615. For example, artificial intelligence such as expert systems, Bayesian networks and/or neural networks can be employed to predict the content of the files based upon the input provided thereto. Accordingly, should the created file(s) vary from what is predicted then the token processing can proceed to 612 where the error are logged and a notification produced. Subsequently the workflow 600 can proceed to 614 and halted.

Alternatively, and if no abnormalities are detected then a notification is sent to a point of sale operator that indicates a successful creation of file(s) at 616. The notification can take the form of a web page including information (e.g. table) about the created files and buttons to view a summary and approve created files. Other mediums of communication that employed to notify an operator can include a short message system (e.g., text messaging), and an instant message system, for example.

The process can then be suspended to wait for a response from the notified individual. If notification fails then such failure can be logged and a user or operator notified at 618. An operator (e.g., at the POS terminal) can view the summary of files that are ready for approval at 620. If, however, an operator initiates viewing of the files and is not able to view the files, then the error can be logged and a notification generated at 622. After a user or operator views the files at 622, the process awaits approval of the file(s) at 624. At 628, the file can be sent to the token issuing bank and/or a payment provider—e.g., based on a predetermined schedule.

Likewise, if it is detected that the files are not sent successfully, then at 630 the failure is logged and a user or operator is notified. Upon successful transmission of the payment token data banks and issuing entities, such files can be deleted at 632, with a notification message sent to the POS, for example.

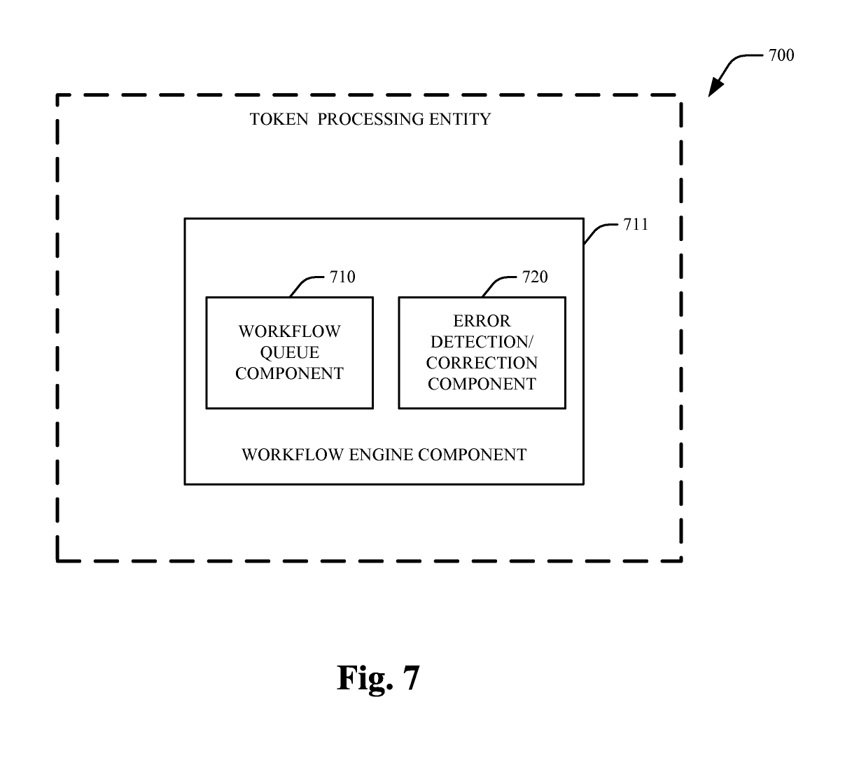

FIG. 7 illustrates a token processing entity 700 that further incorporates an error detection/correction component 720 as part of a token processing according to an aspect of the subject innovation. The workflow engine component 711 includes a workflow queue component 710 and an error detection component 720. As described in detail supra, the workflow engine component 711 orchestrates the execution of workflow tasks. To enable efficient execution of tasks related to processing of tokens, a workflow queue component 710 can be employed, in the form of a database table, list, or stack that specifies the task execution order relative to other tasks, for example.

The workflow engine component 711 employs the workflow queue component 710 to facilitate execution of tasks in order of priority (e.g., highest priority to lowest priority). It is to be appreciated that the workflow engine component 711 can spread tasks over multiple computers having multiple processes with multiple threads and communicate via a network connection. Accordingly, increased efficiency in the execution of workflows can be accomplished by distributing workflows or workflow tasks amongst a plurality of workflow engine components 711 and/or computer systems for execution.

As illustrated, the workflow engine component 711 can further include an error detection/correction component 720 for detecting existence of error during execution of workflow tasks and facilitates easy recovery from an error resulting from among other things a system failure or a network failure. Upon the occurrence of, and detection of an error, the error detection/correction component 720 can compensate for such an error via check pointing, rollback schemes, and the like. For example, in a check pointing scheme a log file is maintained containing safe states. When problems occur, the workflow engine component 711 can restart task execution at the most recently available safe state. In a rollback scheme, effects of actions performed after the error and even before the error can be undone by applying corresponding reverse actions. It is to be appreciated that error avoidance schemes in form of error prediction and avoidance schemes can be employed by the error detection/correction component 720. For example, system stability can be analyzed by the error detection/correction component 720 using statistical methods, neural networks, experts systems and various other adaptive systems and components to predict within a particular threshold the failure of a workflow execution component or the computer system on which it is running. Subsequently, the tasks that were to be executed on the workflow engine component 711 are predicted to fail or otherwise encounter problems can be shifted to another workflow engine component 711 to avoid impending problems.

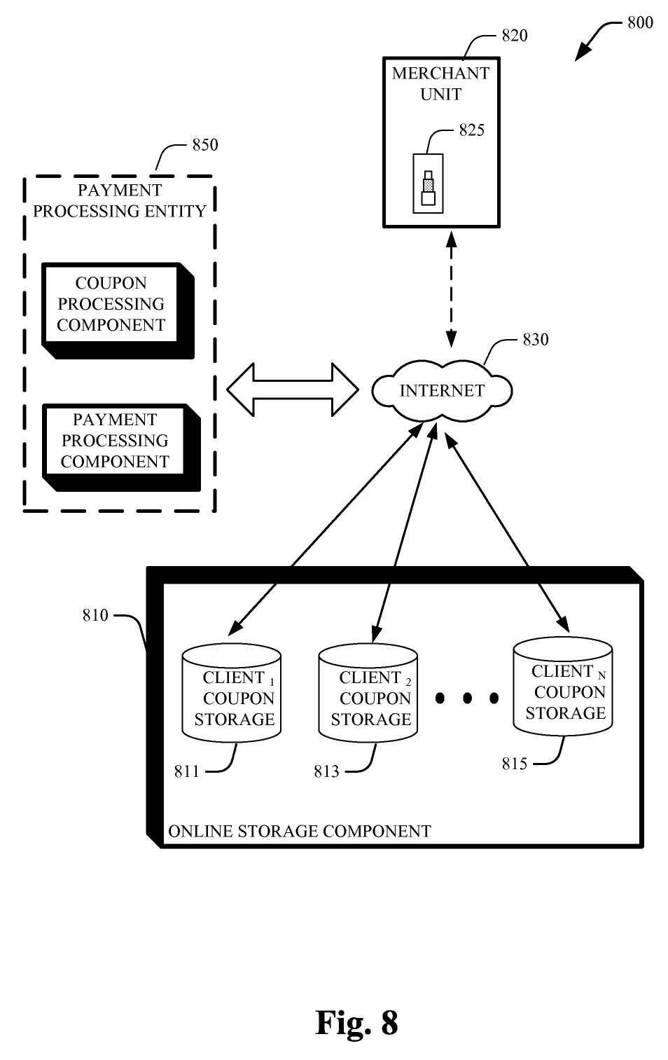

FIG. 8 illustrates a block diagram of a shopping network system 800 that employs an online storage component 810 and combines coupon processing with token processing. The payment processing entity 850 can settle tokens and also function as the coupon clearinghouse between coupon issuers and merchant units 820. Moreover, the shopping network system 800 redeem coupons via an online storage component 810 that stores coupon data for a consumer and regardless of which issuer has issued the coupon. Accordingly, such online storage medium component 810 can store coupons online in storage mediums 811, 813, 815 (1 thru N, where N is an integer) that can represent a single location for each consumer. Such online storage component 810 can operate without being tied to a particular service, and can readily provide redemption (e.g., an automatic redemption). The consumer and other retail entities (e.g., coupon issuers, merchant units 820, and the like) can populate the online storage component periodically, or in response to predetermined events (e.g., physical location of consumer, associated demographics, and the like.) In addition, the merchant terminal 825 can be part of and/or communicatively coupled to the merchant unit 820 via the internet 830.

Moreover, the online storage medium component 810 can function as a live service wherein users (e.g., consumers) can register therewith to store their coupons therein. Accordingly, the online storage component 810 can aggregate coupons collected from a plurality of channels (e.g., paper coupons, electronic coupons) therein—via submission thru the internet 830. Such service can organize collected coupons; facilitate a search thereof, and mange redemption and access to the collected coupons. During a purchase transaction, users redeem coupons that are related to the purchase via an identification process, wherein the terminal 825 (point of sale—POS) receives such coupons and can apply them to the user's shopping basket at checkout. Items in basket of the consumer can be matched with coupons stored for each respective client 811, 813, 815 and rules relating thereto (e.g., discourage using the coupons for the same identical transaction.)

As used in herein, the terms “component,” “system” and the like are intended to refer to a computer-related entity, either hardware, a combination of hardware and software, software or software in execution. For example, a component can be, but is not limited to being, a process running on a processor, a processor, an object, an instance, an executable, a thread of execution, a program and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance or illustration. Any aspect or design described herein as “exemplary” is not necessarily to be construed as preferred or advantageous over other aspects or designs. Similarly, examples are provided herein solely for purposes of clarity and understanding and are not meant to limit the subject innovation or portion thereof in any manner. It is to be appreciated that a myriad of additional or alternate examples could have been presented, but have been omitted for purposes of brevity.

Furthermore, all or portions of the subject innovation can be implemented as a system, method, apparatus, or article of manufacture using standard programming and/or engineering techniques to produce software, firmware, hardware or any combination thereof to control a computer to implement the disclosed innovation. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

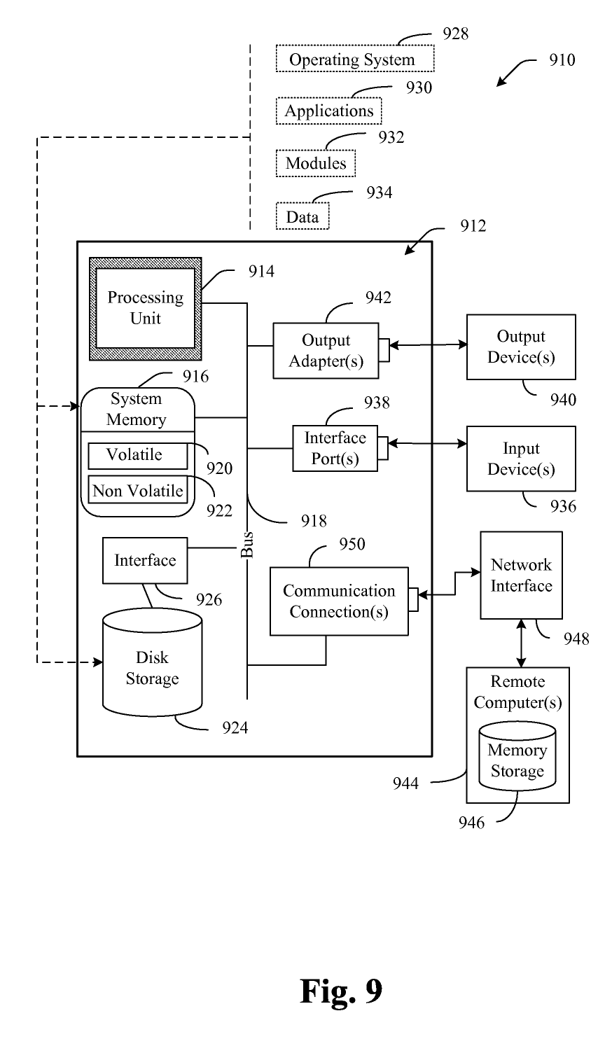

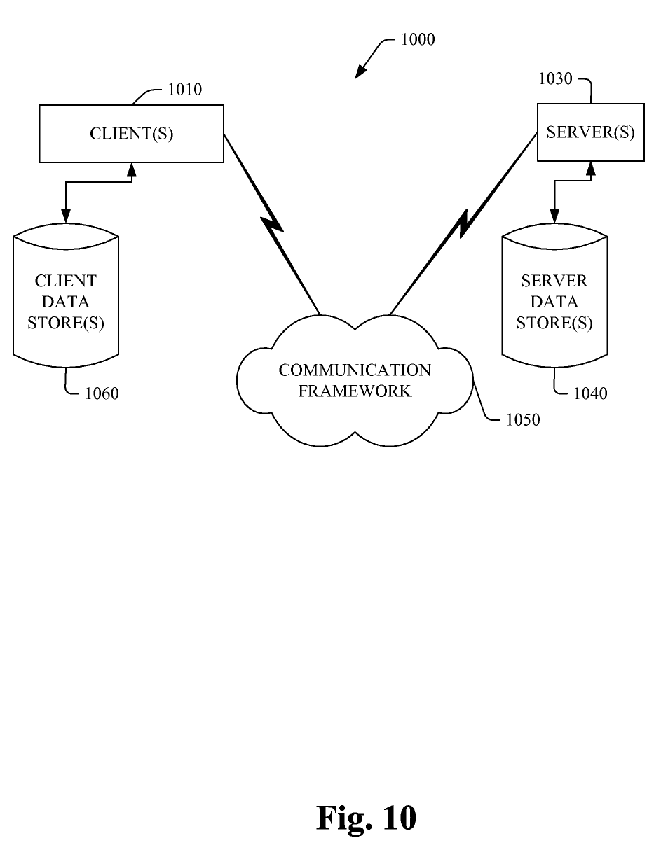

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the innovation also may be implemented in combination with other program modules. Generally, program modules include routines, programs, components, data structures, and the like, which perform particular tasks and/or implement particular abstract data types. Moreover, those skilled in the art will appreciate that the innovative methods can be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the innovation can be practiced on stand-alone computers. In a distributed computing environment, program modules may be located in both local and remote memory storage devices.

With reference to FIG. 9, an exemplary environment 910 for implementing various aspects of the subject innovation is described that includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable ROM (EEPROM), or flash memory. Volatile memory 920 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 912 also includes removable/non-removable, volatile/non-volatile computer storage media. FIG. 9 illustrates a disk storage 924, wherein such disk storage 924 includes, but is not limited to, devices like a magnetic disk drive, floppy disk drive, tape drive, Jaz drive, Zip drive, LS-60 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in suitable operating environment 910. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that various components described herein can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912, and to output information from computer 912 to an output device 940. Output adapter 942 is provided to illustrate that there are some output devices 940 like monitors, speakers, and printers, among other output devices 940 that require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

FIG. 10 is a schematic block diagram of a sample-computing environment 1000 that can be employed as part of a token processing system in accordance with an aspect of the subject innovation. The system 1000 includes one or more client(s) 1010. The client(s) 1010 can be hardware and/or software (e.g., threads, processes, computing devices). The system 1000 also includes one or more server(s) 1030. The server(s) 1030 can also be hardware and/or software (e.g., threads, processes, computing devices). The servers 1030 can house threads to perform transformations by employing the components described herein, for example. One possible communication between a client 1010 and a server 1030 may be in the form of a data packet adapted to be transmitted between two or more computer processes. The system 1000 includes a communication framework 1050 that can be employed to facilitate communications between the client(s) 1010 and the server(s) 1030. The client(s) 1010 are operatively connected to one or more client data store(s) 1060 that can be employed to store information local to the client(s) 1010. Similarly, the server(s) 1030 are operatively connected to one or more server data store(s) 1040 that can be employed to store information local to the servers 1030.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims.

Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer implemented system comprising:
a payment token supplied to a smart portable device by a token issuing entity, the smart portable device carried by a customer during interaction with a merchant unit; and
a point of sale (POS) terminal as part of the merchant unit, the POS terminal receives the payment token from the smart mobile device.

2. The computer implemented system of claim 1 further comprising a processing entity that processes the payment token.

3. The computer implemented system of claim 2, the processing entity further processes coupons.

4. The computer implemented system of claim 2 further comprising a workflow engine component that executes a workflow instance that include a list of tasks related to processing tokens.

5. The computer implemented system of claim 2, the work flow engine further comprising a queue to execute tasks according to priority.

6. The computer implemented system of claim 3 further comprising a notification component that notifies an operator for a required input.

7. The computer implemented system of claim 6 further comprising a monitor component that monitors system resources.

8. The computer implemented system of claim 3 further comprising an error detection component that detects existence of error during execution.

9. The computer implemented system of claim 4 further comprising a log file to restart execution of the workflow at a safe state.

10. The computer implemented system of claim 8 further comprising an interface component that facilitates interaction between an operator and the workflow engine.

11. A computer implemented method comprising:
receiving a payment token by a smart portable device; and
forwarding the payment token to a POS terminal by the smart portable device.

12. The computer implemented method of claim 11 further comprising validating the payment token.

13. The computer implemented method of claim 11 further comprising creating a file containing purchase data for the payment token.

14. The computer implemented method of claim 11 further comprising forwarding the payment token to a merchant bank.

15. The computer implemented method of claim 14 further comprising forwarding customer information to the issuing bank by the smart portable device.

17. The computer implemented method of claim 11 further comprising sending a payment request from the POS to the smart portable device.

18. The computer implemented method of claim 15 further comprising transferring funds by the issuing bank.

19. The computer implemented of claim 11 further comprising forwarding a coupon by the smart portable device to the POS.

20. A computer implemented system comprising:
purchasing means for purchasing an item from a POS; and
means for transferring the purchasing means to a processing entity.
